(19) United States
(12) Patent Application Publication
(10) Pub. No.: US 2013/0154972 A1
(43) Pub. Date: Jun. 20, 2013

(54) TACTILE PRESENTATION DEVICE

(71) Applicant: Kabushiki Kaisha Tokai Rika Denki Seisakusho, Aichi (JP)

(72) Inventor: Shuichi TAKEUCHI, Aichi (JP)

(73) Assignee: KABUSHIKI KAISHA TOKAI RIKA DENKI SEISAKUSHO, Aichi (JP)

(21) Appl. No.: 13/707,073

(22) Filed: Dec. 6, 2012

(30) Foreign Application Priority Data
Dec. 19, 2011 (JP) 2011-276692

(51) Int. Cl. G06F 3/01

(52) U.S. Cl. CPC G06F 3/016
USPC 345/173

(57) ABSTRACT

A tactile presentation device includes a housing, a detection part one end portion of which is rotatably attached to the housing by a supporting member and which is operable to detect an operation performed on an operation surface thereof, and a vibration part attached to the detection part so as to cause the detection part to rotationally vibrate around the supporting member when the detection part detects the operation.

The present application is based on Japanese patent application No. 2011-276692 filed on Dec. 19, 2011, the entire contents of which are incorporated herein by reference.

### BACKGROUND OF THE INVENTION

1. Field of the Invention

This invention relates to a tactile presentation device (or tactile transmitting device) for presenting or transmitting a tactile sense to an operator of the device.

2. Description of the Related Art

As a conventional technique, a touch panel device is known that includes a touch panel configured to detect a touched position due to an operation region of an operator, a lateral direction displacement means configured to displace the touch panel in a lateral direction, and a longitudinal direction displacement means configured to displace the touch panel in a longitudinal direction (for example, refer to JP-A-2003-58321).

The touch panel device causes the touch panel to two-dimensionally vibrate in various patterns by the lateral direction displacement means and the longitudinal direction displacement means, thus it can present a tactile sense to an operator who touches the touch panel.

However, the conventional touch panel device is configured such that the displacement means are arranged in a lateral direction and in a longitudinal direction respectively, thus production cost is increased, in addition, the lateral direction displacement means and the longitudinal direction displacement means are arranged in a side surface of the touch panel, thus it is difficult to reduce the device size.

### SUMMARY OF THE INVENTION

Accordingly, it is an object of the invention to provide a tactile presentation device that has a simple structure so as to be easily downsized and can be manufactured at low cost.
(1) According to one embodiment of the invention, a tactile presentation device comprises:

a housing;

a detection part one end portion of which is rotatably attached to the housing by a supporting member and which is operable to detect an operation performed on an operation surface thereof; and

a vibration part attached to the detection part so as to cause the detection part to rotationally vibrate around the supporting member when the detection part detects the operation.

In the above embodiment (1) of the invention, the following modifications and changes can be made.

(i) The vibration part causes the detection part to vibrate in a direction substantially horizontal to the operation surface.

(ii) The vibration part is attached to a rear surface of an other end portion opposite the one end portion of the detection part.

(iii) The vibration part causes the detection part to vibrate in a direction substantially orthogonal to a longitudinal direction of the detection part.

(iv) The vibration part comprises a vibrator on a rear surface of an other end portion opposite the one end portion of the detection part, and

wherein the vibrator is adapted to vibrate at a constant amplitude and frequency.

(v) The detection part is connected to an electronic device to be controlled according to an increase or decrease of a set value, and

wherein the detection part outputs a detection signal for increasing the set value when an operator traces the operation surface in a direction from the one end portion to the other end portion, and the detection part outputs a detection signal for decreasing the set value when the operator traces the operation surface in a direction from the other end portion to the one end portion.

(vi) The vibration part is operable to provide the operator with a tactile sensing an increase in vibration of the detection part when the operator traces the operation surface in the direction from the one end portion to the other end portion and to provide the operator with a tactile sensing an decrease in vibration of the detection part when the operator traces the operation surface in the direction from the other end portion to the one end portion.

Points of the Invention

According to one embodiment of the invention, a tactile presentation device is constructed such that one end portion of a detection part is rotatably attached to a housing so as to allow a vibration part (vibrator attached to the detection part) at another end portion to cause a predetermined vibration. Therefore it is not needed to control the amplitude and frequency of the vibrator. In other words, the tactile presentation device can use an inexpensive vibrator adapted to vibrate at a constant frequency and amplitude. Thus, the tactile presentation device can be simplified in structure, easily downsized and manufactured at low cost.

### BRIEF DESCRIPTION OF THE DRAWINGS

The preferred embodiments according to the invention will be explained below referring to the drawings, wherein:

FIG. 1A is an explanatory view schematically showing an interior of a vehicle in which a tactile presentation device according to an embodiment of the invention is mounted;

FIG. 1B is an explanatory view schematically showing an arrangement of the tactile presentation device and a display part of an air conditioner;

FIG. 1C is a block diagram with regard to the tactile presentation device and the air conditioner;

FIG. 2A is a top view schematically showing the tactile presentation device according to the embodiment;

FIG. 2B is a cross-sectional view taken along the line II(b)-II(b) in FIG. 2A, and observed in the direction of an arrow;

FIG. 3A is a top view schematically showing a condition of vibration of a vibration part of the tactile presentation device according to the embodiment; and

FIG. 3B is a graph showing a relationship between amplitude of the vibration part and time.

### DETAILED DESCRIPTION OF THE PREFERRED EMBODIMENTS

### Summary of Embodiment

The tactile presentation device according to the embodiment includes a housing, a detection part configured such that one end portion thereof is rotatably installed in the housing by a supporting member so as to detect an operation applied to an operation surface thereof and a vibration part configured such that it adds vibration to the detection part, thereby it causes the detection part to vibrate with a central focus of rotation on the supporting member.

### Embodiment

Configuration of Tactile Presentation Device 1

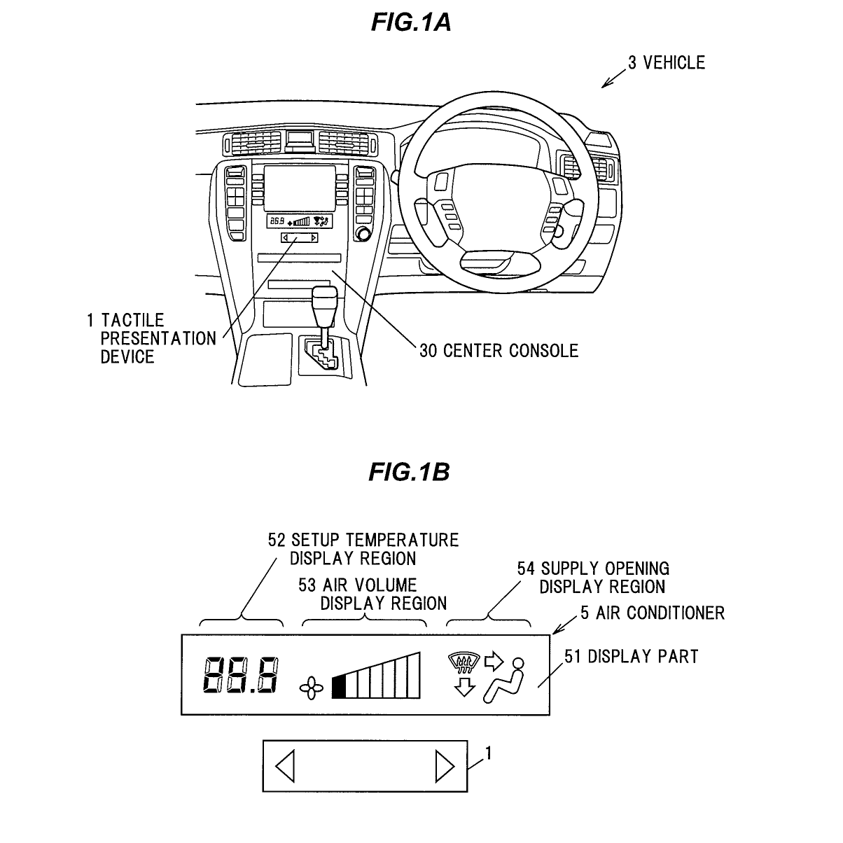

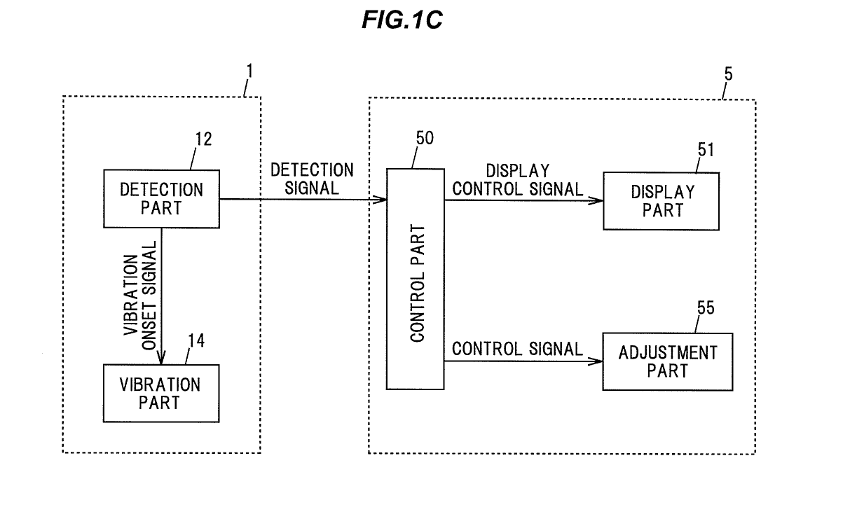

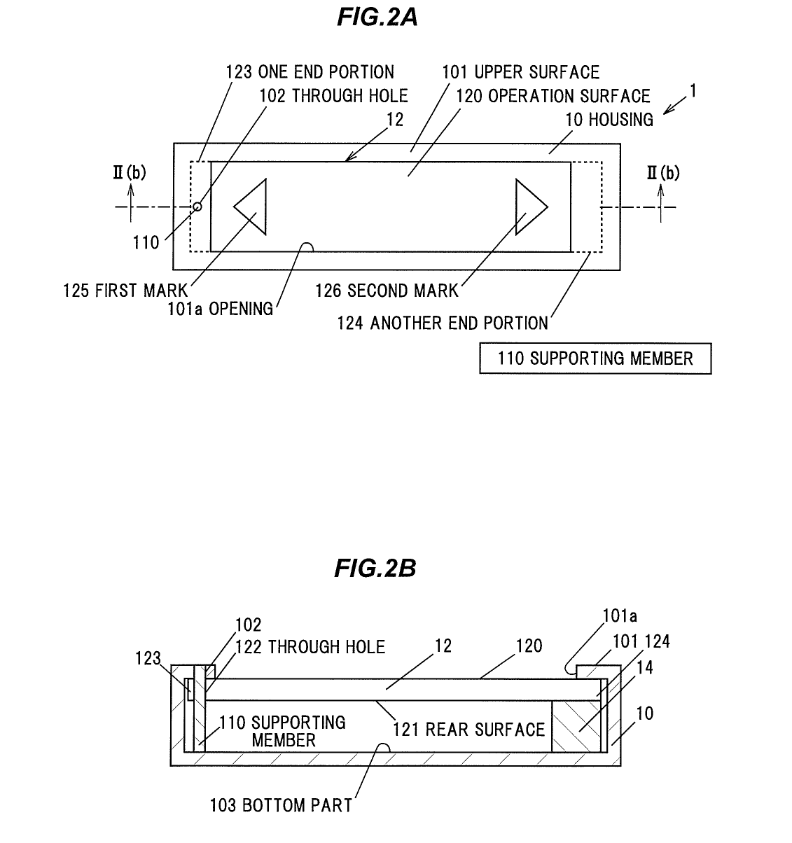

FIG. 1A is an explanatory view schematically showing an interior of a vehicle in which a tactile presentation device according to an embodiment of the invention is mounted, FIG. 1B is an explanatory view schematically showing an arrangement of the tactile presentation device and a display part of an air conditioner and FIG. 1C is a block diagram with regard to the tactile presentation device and the air conditioner. FIG. 2A is a top view schematically showing the tactile presentation device according to the embodiment and FIG. 2B is a cross-sectional view taken along the line II(b)-II(b) in FIG. 2A, and observed in the direction of an arrow. Further, the dimension ratio between constituent elements shown in each of the drawings according to the embodiment is not always as same as the actual dimension ratio therebetween.

The tactile presentation device 1 according to the embodiment is configured, as one example, such that it can setup various set values of electronic devices mounted in the vehicle 3. In addition, the tactile presentation device 1 according to the embodiment is configured such that it setups each of the set values of the air conditioner 5 as an electronic device.

The tactile presentation device 1 is arranged, for example, as shown in FIG. 1A, together with the display part 51 of the air conditioner 5 in the center console 30 installed between a driver's seat and a passenger's seat of the vehicle 3.

In addition, the tactile presentation device 1 is roughly configured to mainly include the housing 10, the detection part 12 configured such that one end portion 123 thereof is rotatably installed in the housing 10 by a supporting member 110 so as to detect an operation applied to an operation surface 120 thereof and a vibration part 14 configured such that it adds vibration to the detection part 12, thereby it causes the detection part 12 to vibrate with a central focus of rotation on the supporting member 110.

Configuration of Housing 10

As shown in FIGS. 2A and 2B, for example, the housing 10 has an elongated boxlike shape, and has an opening 101a formed in an upper surface 101 thereof. The housing 10 is formed by using a synthetic resin material such as polystyrene based resin, polyethylene based resin, polyamide based resin, acrylonitrile-butadiene-styrene resin (ABS resin), or a metallic material such as aluminum, iron, or an alloy material containing the metallic material, or an alloy material such as a stainless steel.

In addition, the housing 10 has, for example, a through hole 102 in the upper surface 101. The supporting member 110 is, for example, inserted into the through hole 102. The supporting member 110 is also inserted into, for example, a through hole 122 of the detection part 12 described below. Namely, the detection part 12 is supported such that it rotates with a central focus of rotation on the supporting member 110.

Configuration of Detection Part 12

The detection part 12 of which one end portion 123 is rotatably installed in the housing 10 by the supporting member 110, vibrates with a central focus of rotation on the supporting member 110.

In addition, the detection part 12 is, for example, a touch sensor that the operation surface 120 is touched by a part (for example, a finger) of body of an operator or a special pen, thereby it detects the touched position on the operation surface 120. The operator applies an operation to, for example, the operation surface 120, thereby it becomes possible to carry out an operation of an electronic device connected. As the detection part 12, a well-known touch panel such as a resistance film type touch panel, a capacitance type touch panel can be used.

The detection part 12 according to the embodiment is, for example, a well-known capacitance type touch panel configured such that a finger touches the operation surface 120, thereby a change of electric current inversely proportional to a distance between an electrode and the finger is output as a detecting signal to an electronic device connected. In addition, the detection part 12 is configured to, for example, output a vibration onset signal showing that the touch of the finger has been detected, to the vibration part 14. The vibration part 14, for example, starts to add vibration to the detection part 12 by using the vibration onset signal as a trigger.

As shown in FIGS. 2A and 2B, for example, the detection part 12 has an elongated plate-like shape. In addition, the detection part 12 has a shape, for example, that is slightly larger than the opening 101a of the housing 10.

As shown in FIGS. 1B and 2A, for example, on the operation surface 120 of the detection part 12, a first mark 125 having a triangular shape and a second mark 126 having a shape obtained by rotating the first mark 125 by 180 degrees clockwise in a plane of FIG. 2A are printed.

Here, the air conditioner 5 is configured, for example, such that if a trace operation (i.e., tracing the operation surface 120 of the detection part 12 with a fingertip) is carried out in a direction of the first mark 125, the set value is decreased based on a detecting signal output from the detection part 12, and if the trace operation is carried out in a direction of the second mark 126, the set value is increased based on a detecting signal output from the detection part 12. If the set value is, for example, a set temperature of air provided from the air conditioner 5, the temperature of the air being adjusted, if the trace operation is carried out in a direction of the first mark 125, the set temperature is lowered, and if the trace operation is carried out in a direction of the second mark 126, the set temperature is elevated.

In addition, the air conditioner 5 is configured, for example, such that if a long press operation is carried out in the vicinity of the first mark 125 of the detection part 12, the set value is decreased in proportion to the operation time. The air conditioner 5 is configured, for example, such that if a short press operation is carried out in the vicinity of the first mark 125, the set value is decreased with a predetermined change width.

Furthermore, the air conditioner 5 is configured, for example, such that if a long press operation is carried out in the vicinity of the second mark 126 of the detection part 12, the set value is increased in proportion to the operation time. The air conditioner 5 is configured, for example, such that if a short press operation is carried out in the vicinity of the second mark 126, the set value is increased with a predetermined change width.

The judgment of the long press operation is carried out, as one example, by a control part 50 of the air conditioner 5, and the control part 50 judges that if the finger is detected such that it remains in a predetermined range for not less than a predetermined time, the long press operation is carried out. In addition, the control part 50 judges that if the finger is detected such that it remains in a predetermined range for less than a predetermined time, the short press operation is carried out. Further, in the embodiment, the judgment of the long press operation and the like is carried out by the control part 50 of the air conditioner 5, but not limited to this, a configuration that the tactile presentation device 1 includes a control part, and outputs the result of judgment of the operation as a detection signal can be also adopted.

Configuration of Vibration Part 14

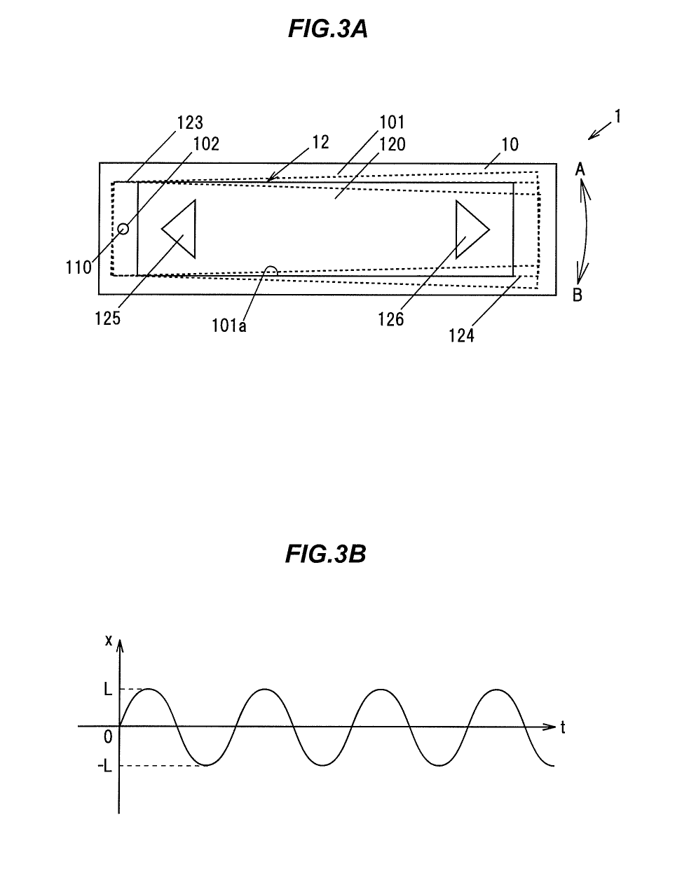

FIG. 3A is a top view schematically showing a condition of vibration of a vibration part of the tactile presentation device according to the embodiment and FIG. 3B is a graph showing a relationship between amplitude of the vibration part and time. In FIG. 3B, the vertical axis shows amplitude (x) and the horizontal axis shows time (t). The amplitude (x) shows, for example, a movement distance of the another end portion 124 of the detection part 12 in a vertical direction in a plane of FIG. 3A. In addition, the amplitude at the time when the detection part 12 is in a resting state is shown as an amplitude (0) in FIG. 3B, the largest amplitude at the upper side in the plane of FIG. 3A is shown as an amplitude (L) in FIG. 3B, and the largest amplitude at the lower side in the plane of FIG. 3A is shown as an amplitude (−L) in FIG. 3B.

The vibration part 14 is configured, for example, such that it adds vibration to the operation surface 120 of the detection part 12 in a direction substantially horizontal (or parallel) to the operation surface 120. In particular, the vibration part 14 is configured, for example, such that it allows the detection part 12 to alternately rotate with a central focus of rotation on the supporting member 110 in an arrow (A) direction and an arrow (B) direction shown in FIG. 3A. The vibration part 14 is, as one example, a horizontal direction vibration type vibrator. As the vibrator, for example, an eccentric motor, a piezoelectric element or the like can be used.

The vibration part 14 is installed, for example, on a rear surface 121 of the another end portion 124 opposite the one end portion 123 of the detection part 12.

In particular, as shown in FIG. 2B, the vibration part 14 is installed on a bottom surface 103 of the housing 10, and is arranged so as to come into contact with the rear surface 121 of the detection part 12. In addition, the detection part 12 is supported, for example, by the vibration part 14 and the rear side of the upper surface 101 of the housing 10.

The vibration part 14 is configured, for example, such that if the vibration onset signal output from the detection part 12 is input, it vibrates at a predetermined frequency. As shown in a dotted line in FIG. 3A, by the vibration of the vibration part 14, the detection part 12 alternately rotates with a central focus of rotation on the supporting member 110 in an arrow (A) direction and an arrow (B) direction with the amplitude (L).

As shown in FIG. 3B, the vibration part 14 vibrates, for example, with the amplitude (L) based on an electric voltage applied thereto. The amplitude (L) of the vibration is, as one example, several μms or several dozen μms. The frequency is, as one example, 150 to 250 Hz.

Configuration of Air Conditioner 5

As shown in FIG. 1C, the air conditioner 5 is roughly configured to, for example, include the control part 50, the display part 51 and the adjustment part 55.

Configuration of Control Part 50

The control part 50 a microcomputer including a Central Processing Unit (CPU) configured to execute calculation, processing and the like to data obtained according to a program stored, a Random Access Memory (RAM) and a Read Only Memory (ROM) that are a semiconductor memory, and the like.

Configuration of Display Part 51

The display part 51 is configured to, for example, include a liquid crystal display. As shown in FIG. 1B, the display part 51 is configured to, for example, have the setup temperature display region 52, the air volume display region 53 and the supply opening display region 54.

The setup temperature display region 52 is, for example, a region configured to show the present setup temperature of the air conditioner 5. The air volume display region 53 is, for example, a region configured to show the present air volume of the air conditioner 5. The supply opening display region 54 is, for example, a region configured to show the supply opening of the vehicle 3 from which temperature-adjusted air is supplied. Further, changes of the set values by the tactile presentation device 1 can be, for example, a change of the air volume and a change of the supply opening.

Configuration of Adjustment Part 55

The adjustment part 55 is configured to, for example, produce an air adjusted so as to be the setup temperature based on the control signal output from the control part 50. In addition, the adjustment part 55 is configured to, for example, be able to supply the adjusted air from the supply opening that is set.

Hereinafter, an operation of the tactile presentation device 1 according to the embodiment will be explained referring to each of the drawings.

Operation

If an operator touches the operation surface 120 of the detection part 12 by his (her) finger in order to set the setup temperature, the vibration part 14 starts to vibrate based on an electric voltage supplied from the electric source of the vehicle 3 by using the vibration onset signal output from the detection part 12 as a trigger.

As shown in FIG. 3A, the detection part 12 alternately rotates with a central focus of rotation on the supporting member 110 in an arrow (A) direction and an arrow (B) direction with the amplitude (L) by the vibration of the vibration part 14.

If the operator carries out, for example, the trace operation in the direction toward the second mark 126 from the first mark 125, he (she) feels larger vibration at his (her) fingertip as it comes closer to the second mark 126.

As shown in FIG. 3A, this is due to the fact that, for example, the supporting member 110 is used as a central focus of rotation, thus the rotating radius of the detection part 12 is enlarged with increasing distance from the supporting member 110. Namely, the vibration is enlarged with decreasing distance from the second mark 126.

Consequently, the operator can feel either increase or decrease in the set values as a tactile sense based on either largeness or smallness of the vibration of the detection part 12 without switching his (her) gaze to the detection part 12.

The control part 50 of the air conditioner 5 controls the adjustment part 55 to actualize the setup temperature instructed on the basis of the detection signal obtained.

Advantages of the Embodiment

The tactile presentation device 1 according to the embodiment is configured such that the one end portion 123 of the detection part 12 is rotatably installed in the housing 10, and a predetermined vibration is added to the another end portion 124 by the vibration part 14, thus it is not needed to control the amplitude and frequency of the vibrator, consequently, in comparison with a device configured to add vibration by a plurality of vibration parts in accordance with the operation position and a device configured to change the frequency, the tactile presentation device 1 according to the embodiment has a simple structure so as to be easily downsized, and can be manufactured at low cost. The tactile presentation device 1 does not need to control the vibrator, thus it does not need to have a control part configured to execute high processing, in addition, it can use an inexpensive vibrator adapted to vibrate at a constant frequency and amplitude.

In addition, if the tactile presentation device 1 is operated in the direction of increasing the set values, the vibration transmitted to the finger of the operator is gradually enlarged, thus a desired operation is easily carried out without switching his (her) gaze to the detection part 12. Namely, the tactile presentation device 1 is configured to differentiate the amplitude of the vibration dependent on the operation position of the finger, thus it can change the perception toward the vibration dependent on the operation position. Consequently, the largeness of the vibration felt by the operator and the operation position create a one-on-one relationship, thus the operator can easily recognize the position of the detection part 12 that he (she) touches without switching his (her) gaze to the detection part 12.

In addition, if the long press operation and the short press operation are applied to the tactile presentation device 1, the operator can also easily recognize either increase or decrease in the set values based on either largeness or smallness of the vibration.

Further, the vibration part 14 used in the above-mentioned embodiment starts to vibrate after approximation or touch of the finger is detected, but not limited to this, as a modification, the tactile presentation device 1 configured such that it starts to vibrate due to the fact that electric voltage is applied thereto can be also adopted.

In addition, in the above-mentioned embodiment, the air conditioner 5 has been exemplified as an electronic device, but not limited to this, as another modification, a music reproduction device, a car navigation device and the like can be also connected to the tactile presentation device 1. If the tactile presentation device 1 is electrically connected to the music reproduction device, sound volume, play order of songs and the like can be set as the set values.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth. In particular, it should be noted that all of the combinations of features as described in the embodiment and Examples are not always needed to solve the problem of the invention.

What is claimed is:

1. A tactile presentation device, comprising:
a housing;
a detection part one end portion of which is rotatably attached to the housing by a supporting member and which is operable to detect an operation performed on an operation surface thereof; and
a vibration part attached to the detection part so as to cause the detection part to rotationally vibrate around the supporting member when the detection part detects the operation.

2. The tactile presentation device according to claim 1, wherein the vibration part causes the detection part to vibrate in a direction substantially horizontal to the operation surface.

3. The tactile presentation device according to claim 1, wherein the vibration part is attached to a rear surface of an other end portion opposite the one end portion of the detection part.

4. The tactile presentation device according to claim 2, wherein the vibration part is attached to a rear surface of an other end portion opposite the one end portion of the detection part.

5. The tactile presentation device according to claim 2, wherein the vibration part causes the detection part to vibrate in a direction substantially orthogonal to a longitudinal direction of the detection part.

6. The tactile presentation device according to claim 1, wherein the vibration part comprises a vibrator on a rear surface of an other end portion opposite the one end portion of the detection part, and
wherein the vibrator is adapted to vibrate at a constant amplitude and frequency.

7. The tactile presentation device according to claim 6, wherein the detection part is connected to an electronic device to be controlled according to an increase or decrease of a set value, and
wherein the detection part outputs a detection signal for increasing the set value when an operator traces the operation surface in a direction from the one end portion to the other end portion, and the detection part outputs a detection signal for decreasing the set value when the operator traces the operation surface in a direction from the other end portion to the one end portion.

8. The tactile presentation device according to claim 7, wherein the vibration part is operable to provide the operator with a tactile sensing an increase in vibration of the detection part when the operator traces the operation surface in the direction from the one end portion to the other end portion and to provide the operator with a tactile sensing an decrease in vibration of the detection part when the operator traces the operation surface in the direction from the other end portion to the one end portion.
